(19) United States
(12) Patent Application Publication
(10) Pub. No.: US 2007/0121626 A1
(43) Pub. Date: May 31, 2007

(54) User and activity based end-to-end utilization measurement system

(76) Inventor: Jeffrey Leonard Gallagher Shepard, Scituate, MA (US)

Correspondence Address: Jeffrey Leonard Shepard, 18 Standish Avenue, Scituate, MA, 02066, US

(21) Appl. No.: 11/604,595

(22) Filed: Nov. 27, 2006

Related U.S. Application Data
(60) Provisional application No. 60/740,570, filed on Nov. 28, 2005.

(51) Int. Cl. H04L 12/56

(52) U.S. Cl. 370/389; 370/252

(57) ABSTRACT

A method and a computer program product embodying software for measuring the utilization of all components in an end-to-end application and automatically associating them with the end-user and end-user activity. One aspect of the invention deals with the measurement and automatic association of server application utilization by the client and the association of the utilization with the end-user and end-user activity. Another aspect of the invention deals with the automatic association of downstream transactions with the client request. Yet another aspect of the invention uses the first two aspects to provide automatic association of utilization measurements of all components in an end-to-end application.

### RELATED APPLICATION

This application claims the priority of U.S. Provisional Application Ser. No. 60/740,570, filed Nov. 28, 2005, and entitled “User- and activity-based end-to-end utilization measurement system”.

### FIELD OF THE INVENTION

The present invention pertains to an end-to-end monitoring and reporting system for information technology (IT) infrastructure cost allocation and accounting, specifically in multi-tiered networked systems.

### BACKGROUND OF THE INVENTION

Information Technology (IT) organizations deploy networks, systems and applications for the benefit of the business units that conduct business activities using them. Often times, these networks, systems and applications are critical to the operation of the business. In many cases, IT organizations chargeback business units for the services provided. The challenge is to accurately measure usage of the resources and charge business units fairly for the usage.

Currently, measurement systems exist to monitor the availability and usability of networks and systems deployed. Products exist, such as IBM's NETVIEW Performance Monitor, Cisco's NETFLOW technology, Hewlett-Packard's NETMETRIX, Computer Associate's NETSPY, to measure aspects of network and system usage. However, these measurement systems do not relate the usage to the individual user and his or her end-to-end activity.

U.S. Pat. No. 5,909,550 describes a correlation technique for managing heterogeneous systems. The technique collects application-specific and protocol-specific measurements and displays them in a central management interface. It does not relate measurements from disconnected systems to the same transaction, nor does it correlate the measurements to the end-user.

U.S. Pat. No. 6,856,942 B2 describes a system, method and model for automatic management of enterprise applications. It collects data from components and analyzing the data to determine one or more issues in the components. The invention focuses on diagnosing problems in enterprise applications not monitoring utilization. Furthermore, the invention requires domain knowledge of the components to correlate them to the application being used. It is constrained by its inability to automatically correlate the data it collects to the end-user.

Lastly, U.S. Pat. No. 6,108,700 describes a system to measure end-to-end response time. It does make an effort to correlate measurement data taken from different points of the end-to-end network, but it relies on administrators to create rules to correlate parts of a transaction. It fails to automatically correlate data and it fails to associate the measurements with an end-user.

Because IT organizations cannot measure actual usage of a given IT resource by a given end-user for a specific activity, they cannot accurately and fairly chargeback end-users or user groups for resources used. Furthermore, IT organizations find it difficult to determine which resources are not being utilized by critical business activities and can therefore be repurposed. The result is significant inefficient use of IT resources.

Thus, there is a need for an improved method and system for measuring and reporting end-to-end usage of networks and systems by end-users and their specific activities.

### SUMMARY

In accordance with the aforementioned needs, the present invention is directed to an improved method and system for measuring and automatically associating usage of various networks and systems in the multi-tiered environment to a specific end-user and his or her specific activity.

The present invention has features which enable the usage of a client system to be associated with a specific end-user and his or her specific activity.

The present invention has other features which enable the network packets generated and received by the client system to also be associated with the end-user and his or her specific activity.

The present invention has still other features which enable the network packets generated and received by a system used by the end-user to be identified at various points along the network and associated with the end-user and his or her specific activity.

The present invention has yet other features which enable network packets received and responded to by a supporting system to be identified and associated with the end-user and his or her specific activity.

The present invention has other features which enable the usage of the supporting system to be associated with the packets received and responded to by the supporting system and, thus, with the end-user and his or her specific activity.

The present invention has still other features which enable the network packets generated and received by the supporting system on behalf of the end-user to also be associated with the end-user and his or her specific activity.

The present invention has yet other features which enable data measured and associated with the end-user and his or her specific activity to be collected and aggregated in one or more locations.

The present invention has other features which enable the end-user and his or her specific activity to be associated with a specific group. An example of the application to chargeback is that usage may to be attributed to a specific business unit and a rate may be assigned for a monthly bill.

In one embodiment of the present invention, Client Agents reside on the client machine and identify end-users as they log into the system. The Client Agents track the end-user's activity and measure the resulting use of client resources. The Client Agents keep audit records and statistics on that usage. As the end-user performs activities that generate and receive network packets, the Client Agent intercepts the packets, tags them with or identifies them by a unique ID that may be associated with the end-user and his or her current activity, and keeps additional audit records and statistics on network usage. Client Agents may report audit records and statistics to one or more Management Stations.

Network Probes may be deployed throughout the network to monitor packets with the unique ID and keep audit records and statistics about them. Network Probes may report audit records and statistics to one or more Management Stations.

Server Agents reside on supporting systems and track both network and system usage. The Server Agents monitor network packets with unique IDs and keep audit records and statistics about them. Additionally, the Server Agents associate running applications with the network packets and, thus, the unique ID. The Server Agents keep audit records and statistics of server resource usage associated with the unique ID. The Server Agents also associate running applications with the network packets they generate to and receive from additional supporting systems. It tags packets generated with a unique ID that may be associated with the end-user. This ID may be the same as the one assigned by the Client Agent or a different unique ID that may be later associated with the one assigned by the Client Agent. The Server Agents keep audit records and statistics of network usage associated with this unique ID. The Server Agents may report all audit records and statistics to one or more Management Stations.

Management Stations collect audit records and statistics from Client Agents, Network Probes and Server Agents and correlate all data gathered with specific end-users and their specific activities. The Management Station may aggregate data and/or generate usage, billing or other reports.

### BRIEF DESCRIPTION OF DRAWINGS

The foregoing and other objects, features and advantages will be better understood from the following detailed description of the invention with reference to the drawings wherein:

FIG. 1A depicts an example of end-user activity over an end-to-end system;

FIG. 1B depicts an example of measuring the end-user activity over an end-to-end system according to the present invention;

FIG. 2 depicts a client system with a client agent measuring end-user activity according to the present invention;

FIG. 3 depicts an example of the flow of execution from a client agent measuring end-user activity resulting in client-generated network traffic;

FIG. 4A depicts an example of a packet tagged in the header without changing the packet size;

FIG. 4B depicts an example of a packet tagged in the header by changing the size of the packet;

FIG. 4C depicts an example of a packet tagged in the data portion of the packet by changing the size of the packet;

FIG. 5 depicts a server system with a server agent measuring end-user activity according to the present invention;

FIG. 6 depicts an example of the flow of execution from a server agent measuring end-user activity resulting in packets received at the server;

FIG. 7 depicts an example of the flow of execution from a server agent measuring end-user activity resulting in server-generated network traffic;

FIG. 8 depicts an example of the features of the present invention for automatically correlating measurements taken by both client and server agents associated with end-to-end end-user activity;

FIG. 9 depicts an example of the features of the present invention for automatically correlating measurements taken by both client and server agents associated with end-to-end activities of multiple end-users;

FIG. 10 depicts an example of the features of the present invention for automatically correlating measurements taken by both client and server agents associated with overlapping end-to-end activities of multiple end-users; and

FIG. 11 depicts an example of the flow of execution from a server agent associating packets from a downstream server with packets to an upstream client or server.

### DETAILED DESCRIPTION

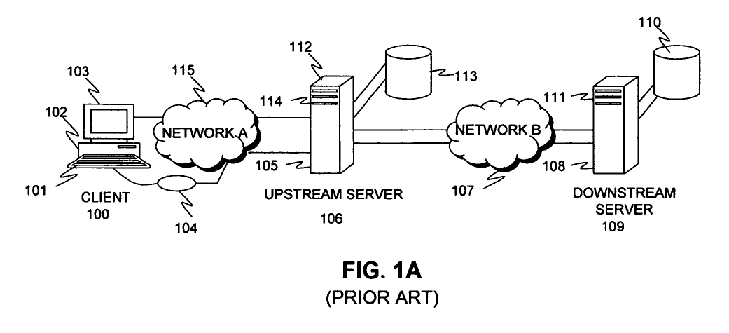

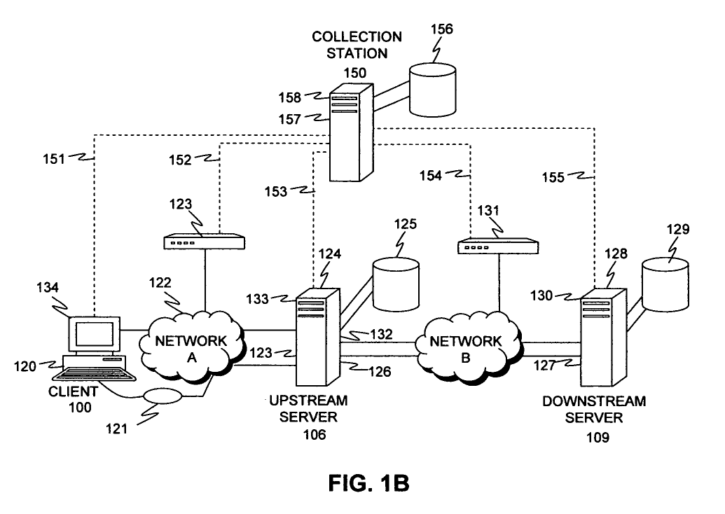

FIG. 1A depicts an example of a multi-tiered client-server application architecture with which the features of the present invention can interact to produce information. As depicted, an end-user uses a client (100) in a specific activity that generates a request, for example, via keyboard (101). Requests, however, could be initiated by any conventional means such as by mouse click, voice command, bar code swipe, etc. Examples of the client (100) are personal computers, laptop computers, handheld computers, personal data assistants, kiosks, data entry terminals, scanners, telephones, mobile phones, pagers, etc. The request is acted upon locally (104) where the request is formulated and forwarded to an application server (106) via a network (115). Examples of the network (115, 107) and communication protocol are socket-based communications riding on TCP/IP transport across a local area network (LAN) that is connected by a router to a wide area network (WAN) containing many switching locations that create a virtual circuit to a service provider and eventually to an upstream server. Examples of the upstream server (106) are high-end personal computers, RISC-based PowerPC's, UNIX-based workstations, minicomputers, or mainframe computers running software fielding requests from clients and distributing the requests to appropriate downstream servers (109) when appropriate. The distinction between upstream servers and downstream servers is made to illustrate that one server may depend on additional servers to process the request from the client. Examples of downstream servers (109) are high-end personal computers, RISC-based PowerPC's, UNIX-based workstations, minicomputers, or mainframe computers running software fielding requests from upstream servers. Examples include, but are not limited to database servers, domain servers, electronic mail servers, web services servers, peer network servers, etc. Upstream servers may depend on any number of downstream servers. Furthermore, each downstream server may depend on any number of additional downstream servers. For discussion purposes we will describe a transaction on just one upstream server and one downstream server. The present invention, however, may apply to any number and combination of upstream and downstream servers.

In the example transaction, the upstream server (106) processes the request (105) and accesses a local database (113) to provide authentication and/or identification of the client (100). The upstream server (106) analyzes (114) the data returned from the database (113) and once determining the client may proceed with the transaction, communicates another request via a network (107) to a downstream server (109). The downstream server (109) processes the request (108), accesses its database (110) and prepares a response (111) to the upstream server (106).

The upstream server (106) receives the response (111) from the downstream server (109) and returns it via the network (115) to the client (100). The client then processes the response (103) to format it for display and presents the response (102) to the initiator to review.

FIG. 1B depicts the system of FIG. 1A including features of the present invention for measuring end-user activity end-to-end. As depicted, a client agent (120) interacts with the software and hardware components on the client (100), probes (123, 131) interact with the software and hardware components on the network, and server agents (133, 130) interact with software and hardware components on the servers (106, 109) and record the performance and utilization of the software and hardware by the end-user and activity (134, 124, 128). Examples of an agent include software written to interact with applications by registering for notification of select conditions (e.g. Windows messaging hooks); software and/or hardware written to intercept activities taken by the business transaction's software and/or hardware (e.g. interception DLL's or shared libraries); insertion of software and/or hardware probes within the business transaction's software and/or hardware (e.g. application plugins); or software and/or hardware written to interact with kernel-level services (e.g. TCP/IP services). Examples of a probe are software and/or hardware connected directly to the network, software and/or hardware connected to routers and/or switches in the network, and software running on routers and/or switches. When an agent or probe measures performance and utilization, it records when and where it measured them, the unique identifier of the transaction, the unique identifier of the end-user, the unique identifier of the software or hardware being measured, and any extra data necessary to uniquely identify the activity being performed.

The collection station (150) collects measurements from the agents and probes (151, 152, 153, 154, and 155) and stores them in a database (156). Software running on the collection station may associate measurements taken from different points in the end-to-end path and may aggregate statistics in any number of ways (157). Examples of aggregations are total utilization of the upstream server by a single end-user activity, total utilization of the upstream server by all activities of a single end-user, total utilization of the upstream server by all end-users for a single activity, etc. Monitoring views and reports may be generated on data collected and aggregated (158). Examples of monitoring are real-time line charts of utilization, real-time bar charts of utilization by server, etc. Examples of reports are total usage by end-user for the week or month for a specific server, total usage of a department for the week or month, etc.

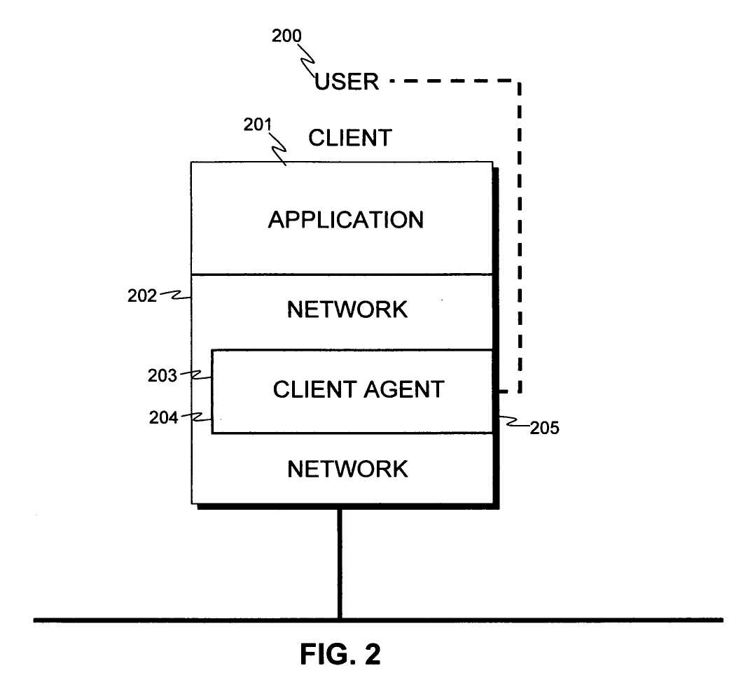

FIG. 2 depicts a client agent (203) running on a client having features of the present invention. The client agent (203) uniquely identifies the end-user (200) performing an activity (201) on the client. Examples of end-user identification techniques are recording system login name, recording application login name, recording software process owner, and explicit prompt for end-user credentials. In addition, the client agent (203) uniquely identifies the end-user activity (201). Examples of end-user activity identification techniques are recording process identification, recording network port numbers, reading application messages, and reading application information (e.g. window title or URL in address bar).

The client agent (203) also monitors or intercepts network packets (202) sent from the client to a server. For each packet, it determines the end-user activity (201) that generated the packet and associates that packet with that activity (205). An example of determining the end-user activity is getting the process ID of the application sending the packets. Another example of determining the application is parsing the packet data to determine the web service or database table being accessed. Examples of associating the packet with the activity are inserting a unique ID into the packet or creating a unique ID from the packet (e.g. a hash of the source address, destination address, port number, and sequence number). The client agent assigns a unique transaction ID (204) to map the end-user activity and the packet ID so that all measurements related to that activity that are recorded throughout the end-to-end network may be associated back to the initiating end-user (200) and activity (201).

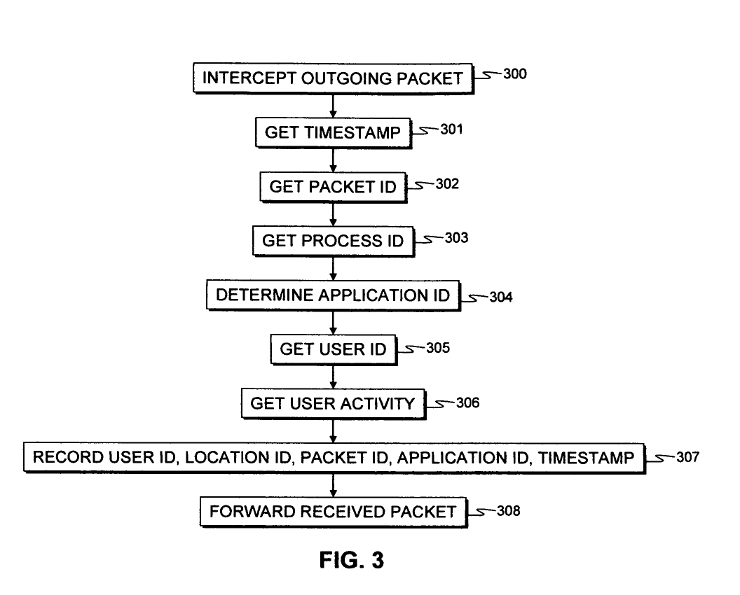

FIG. 3 depicts an example of the flow of execution from a client agent measuring end-user activity resulting in client-generated network traffic. The agent intercepts the outgoing packet (300) generated from an application. It first gets the timestamp (301) to associate the packet with a point in time. Then, it either generates a unique packet ID and inserts it into the packet or creates a unique ID from the packet contents. An example of creating a unique ID is generating a hash of the source address, destination address, port number, and sequence number. Once the packet ID is obtained, the client agent gets the process ID (302) of the application sending the packet. From the process ID, it determines the application ID (304). It then gets the user ID (305) and user activity (306) using one of the techniques described above for FIG. 2. The client agent then records the user ID, location ID, packet ID, application ID and timestamp along with the measurements of performance and utilization (307). Once the record is made, it forwards the packet to its destination (308).

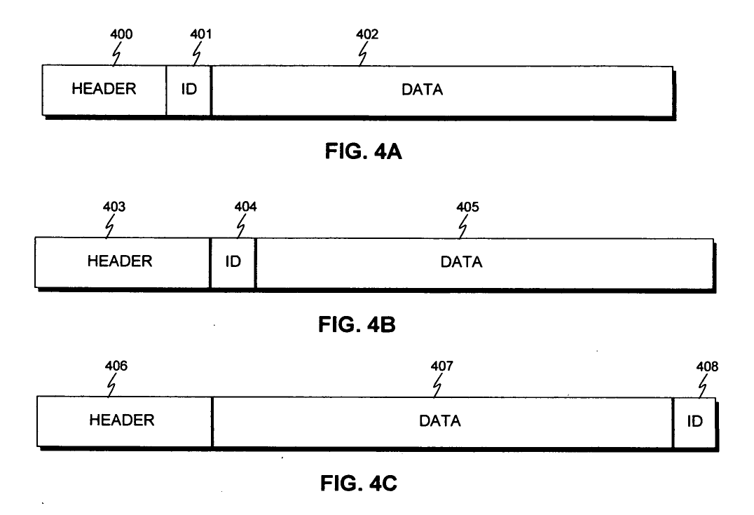

FIG. 4 depicts examples of network packets having features of the present invention. Specifically, FIG. 4 depicts different embodiments for inserting a packet ID into a network packet so that it may be uniquely identified and associated with the end-user activity. FIG. 4A depicts a network packet with a header (400) and data (402). Examples of the contents of the header include source address, destination address, port number, etc. The data portion of the packet contains application-specific data. A unique packet ID is inserted into the header (401) overloading an unused header field.

FIG. 4B depicts the packet ID (404) inserted between the header (403) and the data (405). In this embodiment, the packet size field in the header (403) is updated to include the size of the inserted packet ID.

FIG. 4C depicts the packet ID (408) appended to the data portion (407) of the packet. In this embodiment, the packet size field in the header (406) is updated to include the size of the inserted packet ID.

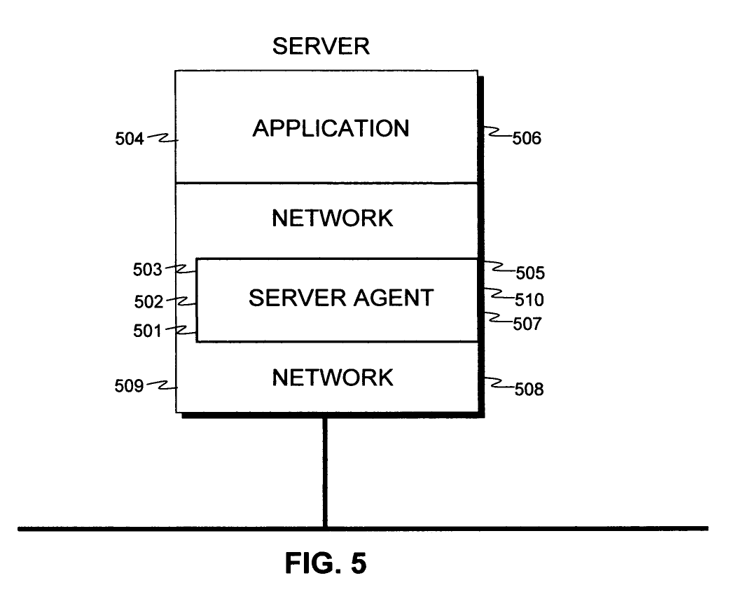

FIG. 5 depicts a server agent (502) running on a server and having features of the present invention. The server agent intercepts network packets (501) from the client and determines the packet ID either by reading it from the packet or calculating the unique hash (e.g. hash of source address, destination address, port, and sequence ID) that is identical to the packet ID calculated on the client. The server agent determines the application receiving the packet (504). An example of determining the application is obtaining the process ID of the process receiving the packet and determining the name of the executable running the process. Another example of determining the application is parsing the packet data to determine the web service or database table being accessed. The server agent records measurements for the transaction in records identified by the unique packet ID (503).

The server agent also monitors or intercepts network packets (505) sent from the server to a downstream server. For each packet, it determines the server application (506) that generated the packet and either generates or records a unique packet ID for that packet before sending the packet (507). An example of determining the server application is getting the process ID of the application sending the packets. Another example of determining the application is parsing the packet data to determine the web service or database table being accessed.

In addition, the server agent monitors or intercepts responses from downstream servers (508). When it receives a response, it checks for any requests received from the client or upstream server (501) that have not yet been responded to (509). If it finds only one, it associates the request (507) and response (508) to/from the downstream server to the request (501) and response (509) from/to the client or upstream server. Once associated, the measurements made for the downstream transaction (507, 508) may be associated with the end-user activity represented by the upstream transaction (501, 509) and may be assigned the same packet ID (503) derived from the upstream request (501).

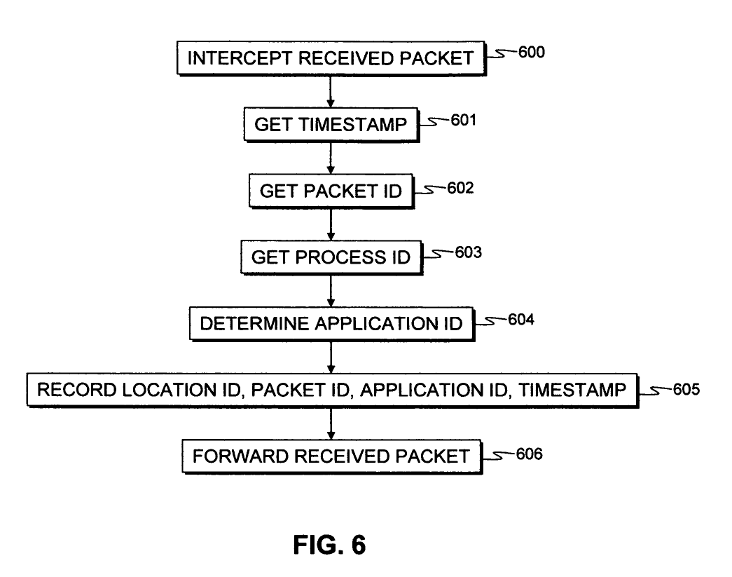

FIG. 6 depicts an example of the flow of execution from a server agent measuring end-user activity resulting in packets received at the server. The agent intercepts the incoming packet (600) received from the client or upstream server. It first gets the timestamp (601) to associate the packet with a point in time. Then, it either generates a unique packet ID and inserts it into the packet or creates a unique ID from the packet contents that matches the one created by the client (602). An example of creating a unique ID is generating a hash of the source address, destination address, port number, and sequence number. Once the packet ID is obtained, the server agent gets the process ID (603) of the application receiving the packet. From the process ID or other application identifying technique, it determines the application ID (604). The server agent then records the location ID, packet ID, application ID and timestamp along with the measurements of performance and utilization (605). Once the record is made, it forwards the packet to the application (606).

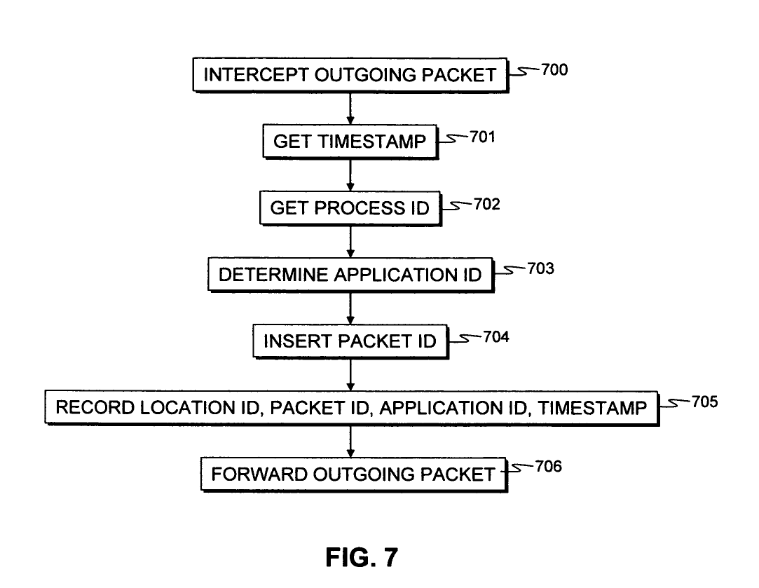

FIG. 7 depicts an example of the flow of execution from a server agent measuring end-user activity resulting in server-generated network traffic. The agent intercepts the outgoing packet (700) generated from an application. It first gets the timestamp (701) to associate the packet with a point in time. It then gets the process ID (702) of the application sending the packet. From the process ID or another application identification technique, it determines the application ID (703). Then, it either generates a unique packet ID and inserts it into the packet or creates a unique ID from the packet contents (704). An example of creating a unique ID is generating a hash of the source address, destination address, port number, and sequence number. The server agent then records the location ID, packet ID, application ID and timestamp along with the measurements of performance and utilization (705). Once the record is made, it forwards the packet to its destination (706).

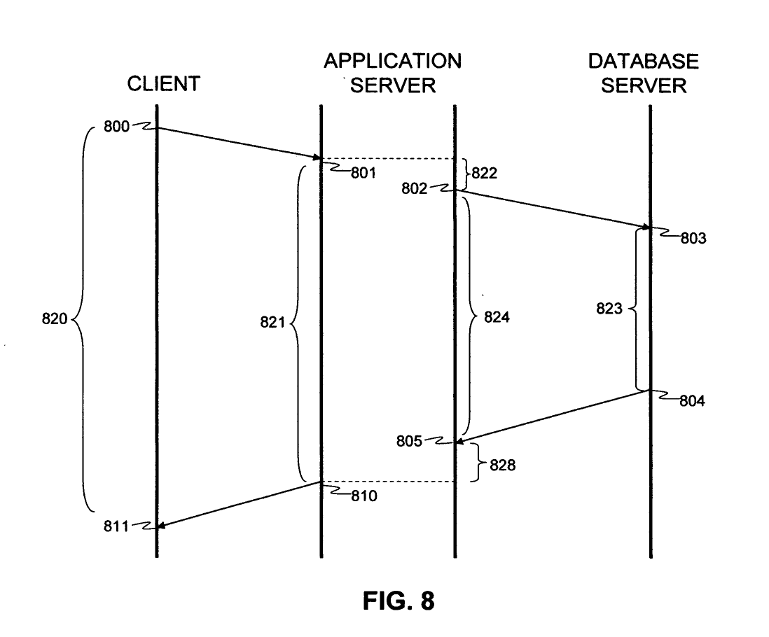

FIG. 8 depicts an example of the features of the present invention for automatically correlating measurements taken by both client and server agents associated with end-to-end end-user activity. An end-user initiates an activity that generates a network request (800) from the client to the application server. The client agent records the time of the request and inserts a packet ID into the request (800). The agent also records the user ID and application ID of the application generating the request (800).

The request is received by the application server (801). The server agent identifies the packet ID, removes the packet ID, marks the time of receipt of the request (801). It also identifies the application ID of the application processing the request (822) and records the information by the packet ID. The application running on the server performs some work (822) that results in a request to the database (802). The server agent intercepts the request (802) and determines the application ID of the application sending it (822). It marks the time of the request and inserts a second packet ID into the request (802).

The database receives the request from the application server (803). The server agent running on the database server identifies the second packet ID, removes the packet ID, and marks the time of receipt of the request (803). It also identifies the application ID of the application processing the request (823) and records the information by the second packet ID. The database server application executes a query and replies to the request (803) with a response (804). The server agent on the database server intercepts the response (804) and inserts the second packet ID it received in the request (803). It also calculates transaction time (823) for its transaction and records this information by the second packet ID so that it may be associated with the application server request and, eventually, the end-user and activity.

The application server receives the response from the database (805). The server agent on the application server intercepts the response (805), removes the packet ID, measures the response time of the transaction (824) and records this information by the second packet ID. Upon identifying the response (805) and associating it by its packet ID to the request (802), it then checks for any outstanding requests from the client. It finds one outstanding client request (801). Identifying that both the request (802) and response (805) to/from the database occur after receiving the client request (801) and before the response to the client (810), the server agent determines that the transactions with the database (824, 823) are associated with the client transactions (821, 820). The server agent associates all measurements associated with the second packet ID with all the measurements associated with the first packet ID. It then forwards the response (805) to the application to be processed.

The application running on the application server performs more work (828) that results in a response (810) to the client. The server agent running on the application server intercepts the response (810). It calculates the total transaction time (821) for the application server and records that by the first packet ID. It forwards the response to the client.

The client receives the response (811). The client agent on the client intercepts the response (811), removes the packet ID, measures the response time of the transaction (820) and records this information by the first packet ID. It then associates the transaction (820) with the first packet ID, the end-user and the end-user activity. When the collection station collects measurements from the client agent, application server agent, and database server agent, it can automatically associate all measurements (823, 824, 821, and 820) with the first packet ID and the end-user and activity.

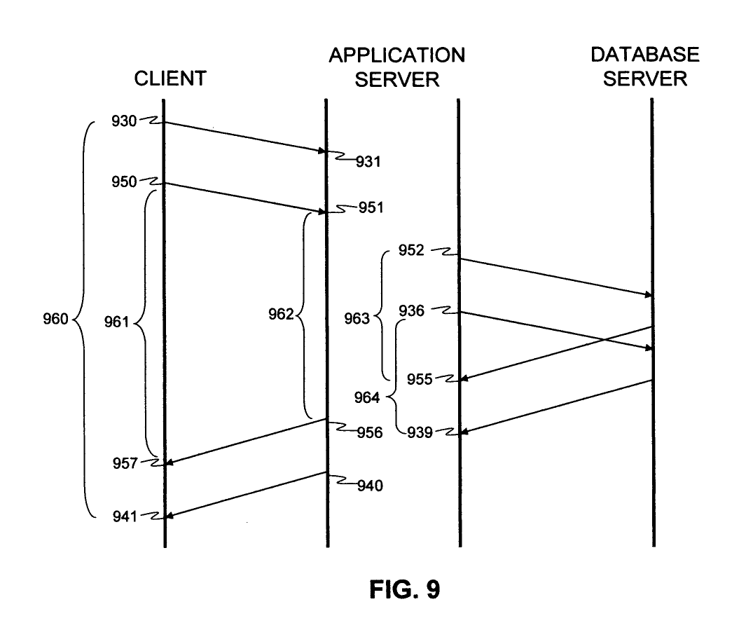

FIG. 9 depicts an example of the features of the present invention for automatically correlating measurements taken by both client and server agents associated with end-to-end activities of multiple end-users. The first end-user initiates a request (930) before the second (950). The first is received by the application server (931) before the second (951). However, in this example, two requests are made to the database (952, 936) after the client requests are received (931, 951). The response to the first database request (955) is received by the application server before either response to the client (956 or 940) is made. Therefore, the transaction (963) cannot be uniquely associated with a client transaction (960 or 961) based on time correlation. In this scenario, the server agent on the application server may mark the transaction (963) with the IDs of both the first and second transactions (960 and 961). The administrator may associate the database transaction with the appropriate client transaction manually.

Additionally, the server agent may automatically develop associations between downstream application IDs and upstream application IDs. For example, FIG. 8 shows an example where automatic time-based correlation is possible. This correlation may be used to associate the downstream application ID with the upstream application ID either in advance of or after an overlapped transaction is encountered. The server agent may use the association to correlate overlapped transactions by these application ID associations.

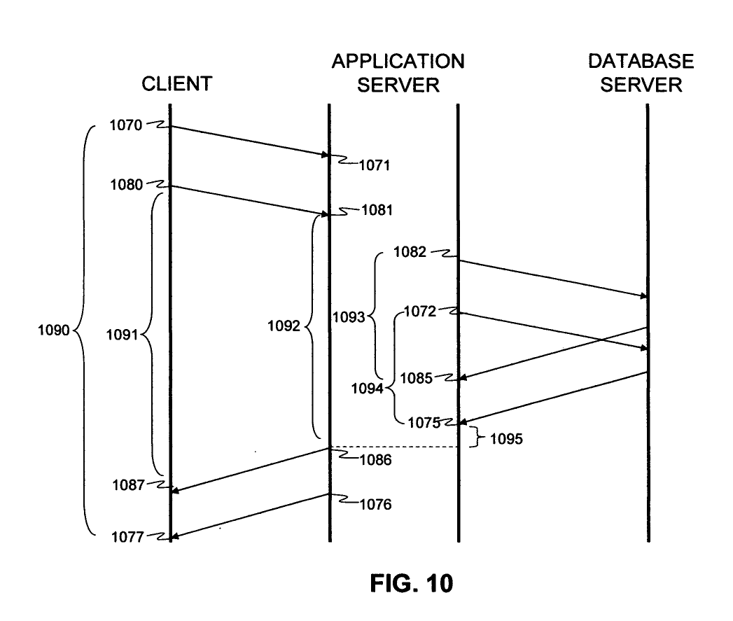

FIG. 10 depicts an example of the features of the present invention for automatically correlating measurements taken by both client and server agents associated with overlapping end-to-end activities of multiple end-users. In this example, two database transactions (1093 and 1094) both occur within the timeframe of both client transactions (1090 and 1091). In this scenario, the server agent on the application may mark both transactions (1093 and 1094) with the IDs of both the first and second client transaction (1090 and 1091). Using application ID associations discussed above, the server agent may either at that time or at a later time associate the downstream transaction with the upstream transaction. Additionally, the administrator may associate the database transactions with the appropriate client transactions manually.

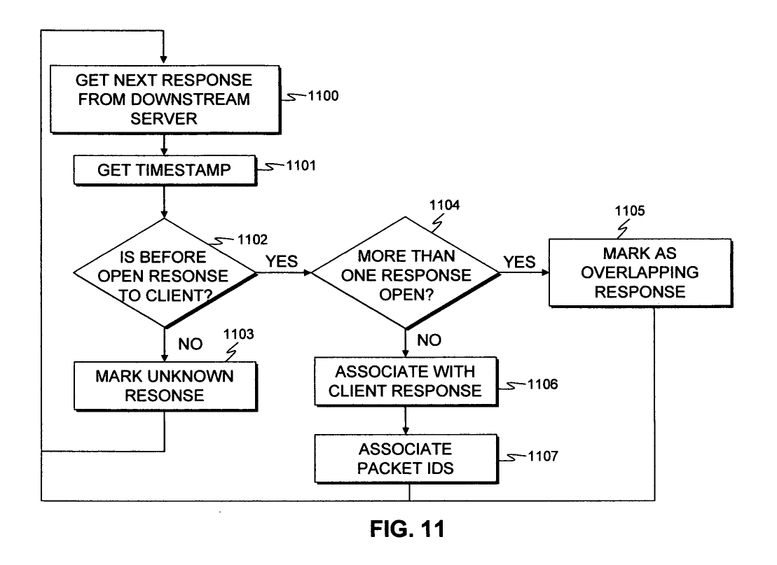

FIG. 11 depicts an example of the flow of execution from a server agent associating packets from a downstream server with packets to an upstream client or server. The server agent first gets a response back from the downstream server (1100). It gets its timestamp (1101) and determines whether the response is before a response open to a client (1102). A response is before an open response to a client if the client request was received before the request to the downstream server and the response from the downstream server was received before the response sent back to the client. If the response from the downstream server is not before the response to the client, it is marked as unknown (1103). This is an error condition. If the response from the downstream server is before the response to the client, then it is further checked to determine whether more than one response to a client is open (1104). If more than one is open, then the response from the downstream server should be marked as an overlapping response (1105). Examples of overlapping responses were given in FIG. 9 and FIG. 10. If more than one is not open, in other words, only one is open then the server agent should associate the response from the downstream server with the response to the server (1106) and associate the packet IDs (1107). An example of this is in FIG. 8.

Now that the invention has been described by way of a detailed description, various improvements, alternatives and equivalents will become apparent to those skilled in the art. Thus, it should be understood that the detailed description has been provided by way of an example and not as a limitation. The scope of the invention is properly defined by the appended claims.

We claim:

1. In a system wherein an end-user performing an activity within an application on a client causes the application to request services from a server, a method for associating utilization of the server with the client application, the end-user and his or her activity, comprising the steps of:
associating an end-user activity with the end-user;
associating a client application with the end-user activity;
identifying network packets sent from the client application to a server;
associating network packets sent from the client to a server with the client application;
tagging or uniquely identifying the packets sent from the client to the server.
marking the time that the packets are sent from the client to the server;
identifying on the client response packets from the server by their tag or unique ID;
marking the time that the packets are received from the server by the client;
associating network packets received by the client from the server with the client application;
calculating the utilization of the server based on the times marked for the network packets;
associating utilization of the server with the client application;
associating utilization of the server with the end-user activity; and
associating utilization of the server with the end-user.

2. In a system wherein a client application requests services from a server, a method for associating utilization of the server application with a client request, comprising the steps of:
identifying on the server the packets from the client by their tag or unique identifier;
marking the time that the packets are received from the client by the server;
associating the packets received from the client with the server application handling them;
identifying network packets sent from the server back to the client in response to the client application;
marking the time that the packets are sent from the server to the client;
associating network packets sent back to the client with the server application;
calculating the utilization of the server application based on the times marked for the network packets;
associating the utilization of the server application with the client request;

3. In a system wherein a client application requests services from a server and the server relies on one or more downstream servers, a method for automatically associating requests to a downstream server with requests from the client, comprising the steps of:
identifying on the server the packets from the client by their tag or unique identifier;
marking the time that the packets are received from the client by the server;
associating the packets received from the client with the server application handling them;
identifying network packets sent from the server application to a downstream server;
associating network packets sent from the server to a downstream server with the server application that generated them;
tagging or uniquely identifying the packets sent from the server to the downstream server.
marking the time that the packets are sent from the server to the downstream server;
identifying on the response packets from the downstream server by their tag or unique ID;
marking the time that the packets are received from the downstream server by the server;
associating network packets received by the server from the downstream server with the server application that sent the request;
calculating the utilization of the downstream server by the server based on the times marked for the network packets;
identifying network packets sent from the server back to the client in response to the client application;
associating network packets sent back to the client with the server application;
marking the time that the packets are sent from the server to the client;
associating packets sent and received to/from the downstream server after packets were received from the client and before responses were sent to the client with the client request and response;

4. In a system wherein a client application requests services from a server and the server relies on one or more downstream servers, a method for measuring utilization of both the server and downstream server and automatically associating them with requests from the client, comprising the steps of:
identifying on the server the packets from the client by their tag or unique identifier;
marking the time that the packets are received from the client by the server;
associating the packets received from the client with the server application handling them;
identifying network packets sent from the server application to a downstream server;
associating network packets sent from the server to a downstream server with the server application that generated them;
tagging or uniquely identifying the packets sent from the server to the downstream server.
marking the time that the packets are sent from the server to the downstream server;
identifying on the response packets from the downstream server by their tag or unique ID;
marking the time that the packets are received from the downstream server by the server;
associating network packets received by the server from the downstream server with the server application that sent the request;
calculating the utilization of the downstream server by the server based on the times marked for the network packets;
identifying network packets sent from the server back to the client in response to the client application;
associating network packets sent back to the client with the server application;
marking the time that the packets are sent from the server to the client;
calculating the utilization of the server application based on the times marked for the network packets;
associating the utilization of the server application with the client request;
associating packets sent and received to/from the downstream server after packets were received from the client and before responses were sent to the client with the client request and response;
associating the utilization of the downstream server application with the client request;

5. In a system wherein an end-user performing an activity within an application on a client causes the application to request services from a server and the server relies on one or more downstream servers, a method for measuring utilization of the server and all downstream servers and automatically associating them with the client application, the end-user and his or her activity, comprising the steps of claim 1, the steps from claim 4, and the steps of:
associating the utilization of the server application and all downstream server applications with the client request;
associating the utilization of the server application and all downstream server applications with the client application;
associating the utilization of the server application and all downstream server applications with the end-user activity; and
associating the utilization of the server application and all downstream server applications with the end-user.
